(19) United States
(12) Patent Application Publication
(10) Pub. No.: US 2008/0230597 A1
(43) Pub. Date: Sep. 25, 2008

(54) Electronic Money Charger

(75) Inventor: Yasunari NAKAJIMA, Sawa-gun (JP)

Correspondence Address: BANNER & WITCOFF, LTD., 1100 13th STREET, N.W., SUITE 1200, WASHINGTON, DC, 20005-4051, US

(73) Assignee: SANDEN CORPORATION, Gunma (JP)

(21) Appl. No.: 12/048,396

(22) Filed: Mar. 14, 2008

(30) Foreign Application Priority Data
Mar. 19, 2007 (JP) 2007-070012

(51) Int. Cl. G06Q 40/00

(52) U.S. Cl. 235/379

(57) ABSTRACT

The present invention provides an electronic money charger in which an inserted currency returned when an anomaly has occurred in an electronic money deposit process is not carried away. An electronic money charger of the present invention is provided with a banknote receiving unit which receives an inserted banknote, a human sensor which detects a user who has inserted the banknote, and a control unit which controls to prepare for returning the inserted currency when the anomaly has occurred in the electronic money deposit process and also to store the inserted banknote in the banknote receiving unit if the user has not been detected by the human sensor in a state prepared for returning the inserted banknote.

### BACKGROUND OF THE INVENTION

1. Field of the Invention

The present invention relates to an electronic money charger which performs an electronic money deposit process with respect to a storage medium which stores an electronic money balance in an electronic money service used for, for example, an electronic ticket, electronic payment or the like.

2. Description of the Related Art

Conventionally, as this kind of electronic money charger, there has been known an electronic money charger which is provided with a reader/writer which reads and writes data with respect to a storage medium in which an electronic money balance used in an electronic money service has been stored, and which performs an electronic money deposit process by adding an amount of an inserted currency to the electronic money balance in the storage medium via the reader/writer (for example, see Japanese Patent Publication 2003-36466).

In such an electronic money charger, when an anomaly occurs in the electronic money deposit process after the currency has been inserted, the inserted currency is returned by exposing the inserted currency in a state where a user can remove the inserted currency.

However, in the above described prior art, for example, even though the anomaly has occurred in the electronic money deposit process, even if the user has mistakenly recognized that the deposit process has been normally completed, and left there, the inserted currency is simply returned. Therefore, it is possible for anyone to remove the inserted currency which has been returned, and the inserted currency may be carried away by a third party.

### BRIEF SUMMARY OF THE INVENTION

The present invention has been made in view of the above described problems, and an object of the present invention is to provide an electronic money charger in which an inserted currency returned when an anomaly has occurred in an electronic money deposit process is not carried away.

To achieve the above described object, the electronic money charger of the present invention is provided with a reader/writer which reads and writes data with respect to a storage medium in which an electronic money balance used in an electronic money service has been stored, a currency receiving unit which receives an inserted currency, a user detection unit which detects a user who has inserted the currency, and control means which has control to perform an electronic money deposit process by adding an amount of the inserted currency to the electronic money balance in the storage medium via the reader/writer, control to enable the inserted currency to be returned when an anomaly has occurred in the above described deposit process, and control to store the inserted currency in the currency receiving unit if the user has not been detected by the user detection unit in a state where the inserted currency is returnable.

Thereby, if the user has not been detected by the user detection unit in the state where the inserted currency is returnable because the anomaly has occurred in the electronic money deposit process, the inserted currency is stored in the currency receiving unit. Consequently, for example, even though the anomaly has occurred in the electronic money deposit process, if the user has mistakenly recognized that the deposit process has been normally completed, and left there, the inserted currency can be stored in the currency receiving unit. Therefore, in the present invention, it is possible to prevent the inserted currency which has been returned, from being freely removed, and also possible to certainly prevent the inserted currency from being carried away by a third party.

### BRIEF DESCRIPTION OF SEVERAL VIEWS OF THE DRAWINGS

FIG. 1 is a perspective view of an electronic money charger showing an embodiment of the present invention;

FIG. 2 is a functional configuration diagram of the electronic money charger;

FIG. 3 is a functional configuration diagram of a contactless IC card;

FIG. 4 is a diagram showing an example of a data structure of history information;

FIG. 5 is a diagram showing an example of a data structure of amount information;

FIG. 6 is a flowchart illustrating operations of a control unit; and

FIG. 7 is a diagram showing information displayed on a display unit.

### DETAILED DESCRIPTION OF THE INVENTION

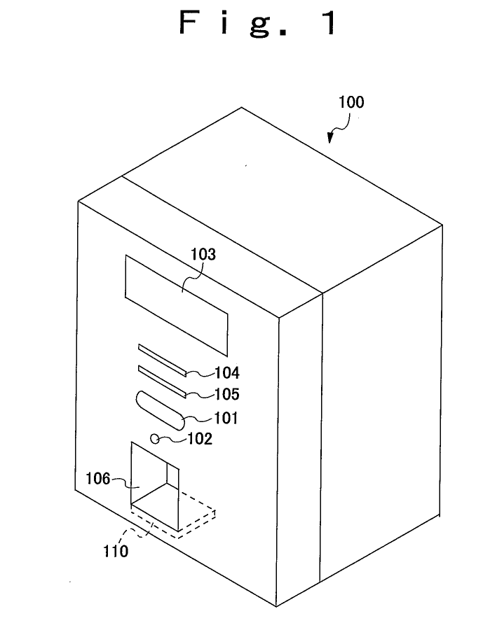

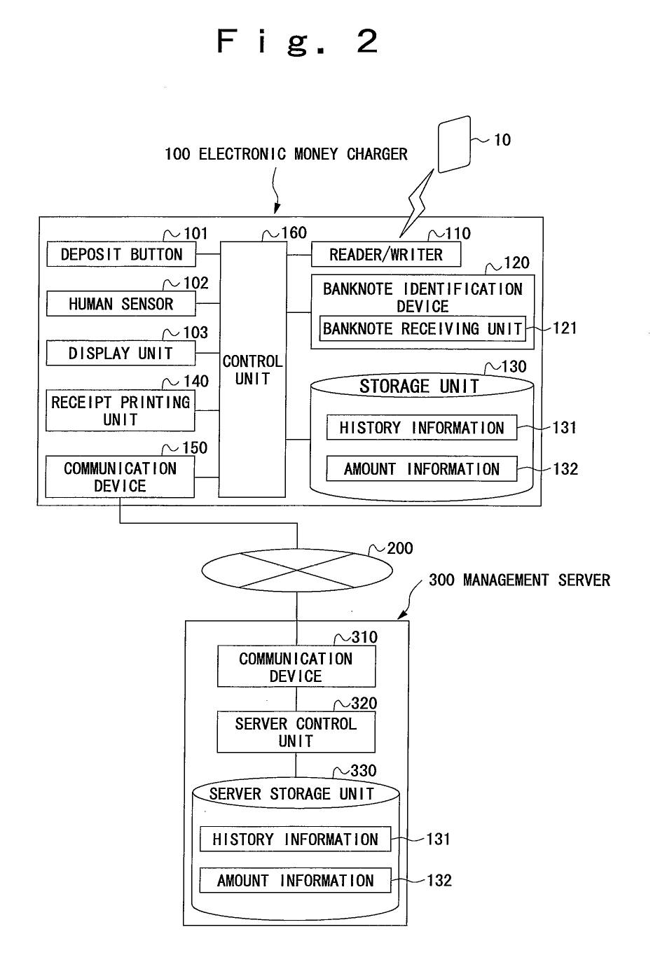

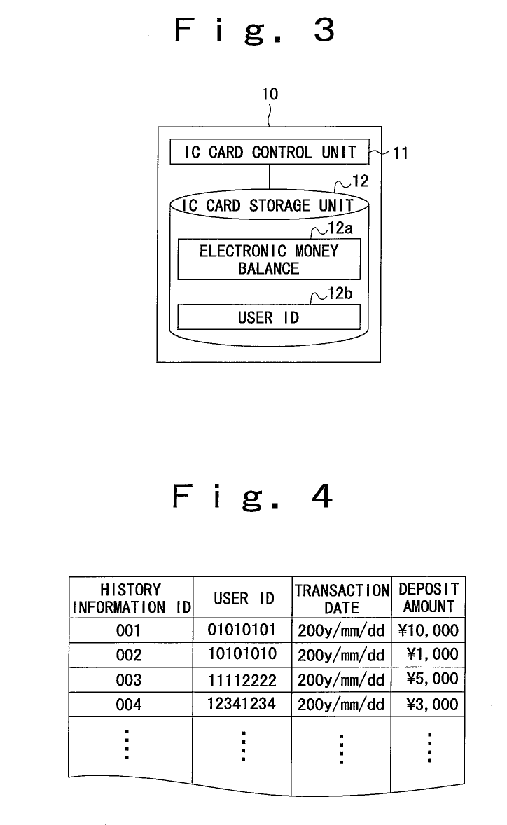

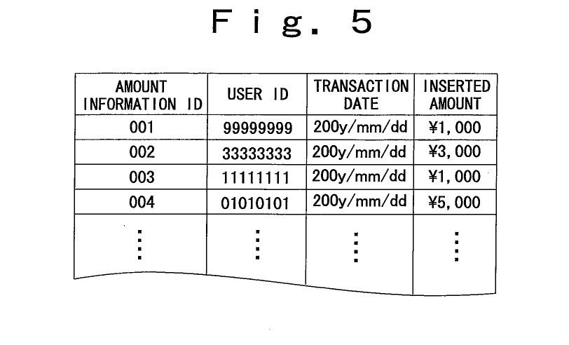

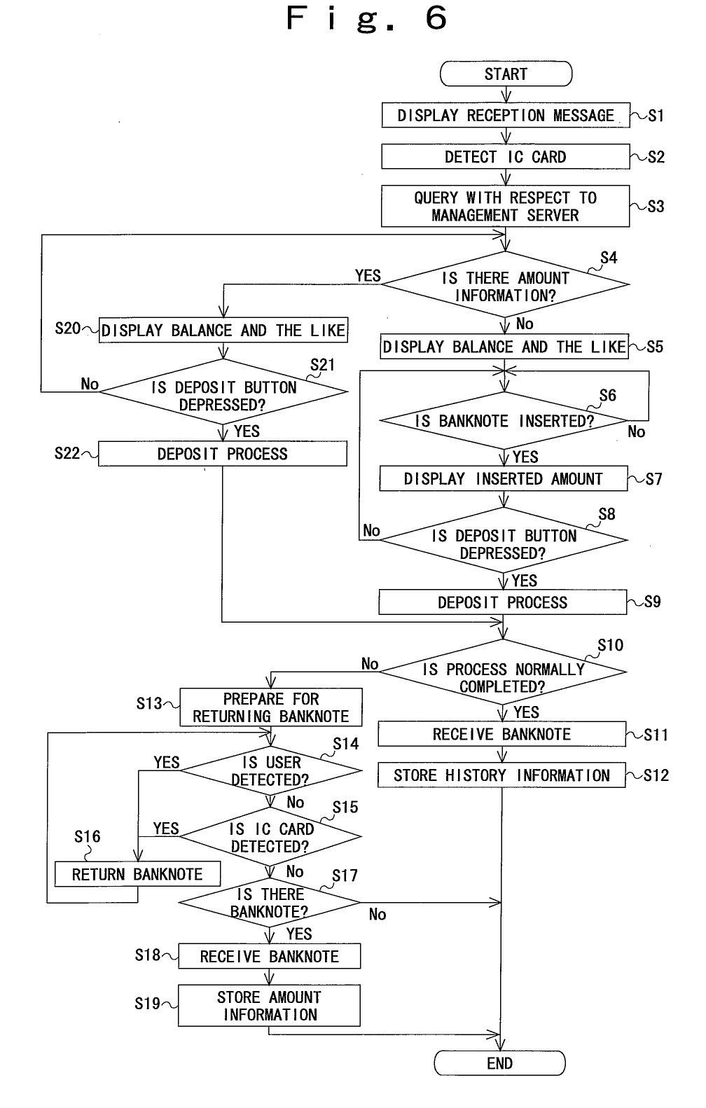

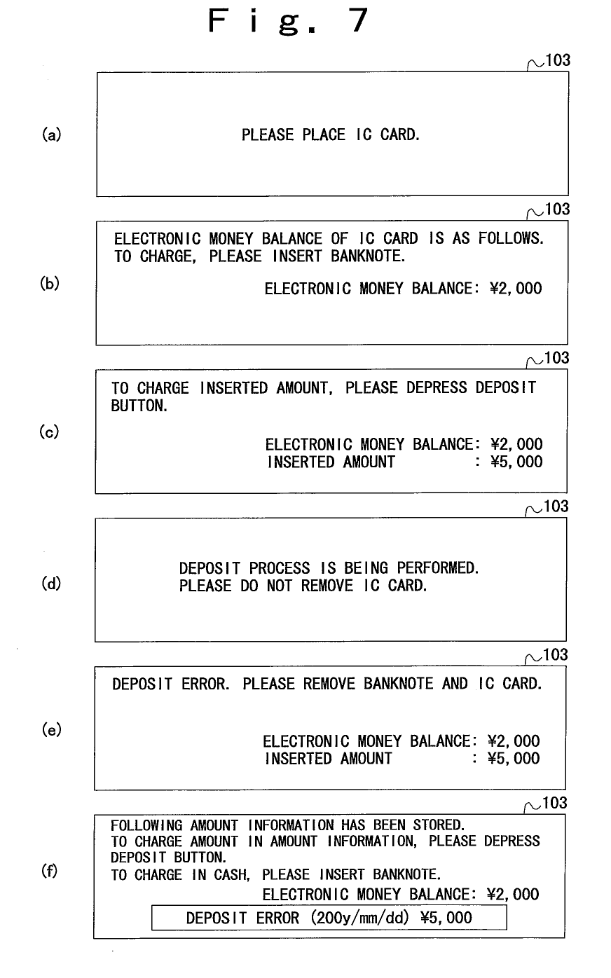

FIGS. 1 to 7 show an embodiment of the present invention, and FIG. 1 is a perspective view of an electronic money charger, FIG. 2 is a functional configuration diagram of the electronic money charger, FIG. 3 is a functional configuration diagram of a contactless IC card, FIG. 4 is a diagram showing an example of a data structure of history information, FIG. 5 is a diagram showing an example of a data structure of amount information, FIG. 6 is a flowchart illustrating operations of a control unit, and FIG. 7 is a diagram showing information displayed on a display unit.

An electronic money charger 100 of this embodiment performs an electronic money deposit process by adding an amount of an inserted banknote to an electronic money balance of a contactless IC card 10.

As shown in FIG. 1, the electronic money charger 100 is provided with a deposit button 101 for starting the electronic money deposit process, a human sensor 102 as a user detection unit for detecting a user who has inserted the banknote, a display unit 103 for displaying information on the deposit process, a banknote insertion slot 104, a receipt ejection slot 105 for ejecting a receipt on which a result of the deposit process has been printed, and a card placement unit 106 in which its front side is open, at a front side thereof. Moreover, as shown in FIG. 2, within the electronic money charger 100, a reader/writer 110, a banknote identification device 120, a storage unit 130, a receipt printing unit 140, a communication device 150 and a control unit 160 are provided, and the above described respective devices are connected to the control unit 160. Furthermore, the electronic money charger 100 is connected to a management server 300 for an electronic money service via a network 200.

In the contactless IC card 10, a coil-shaped antenna (not shown) for transmitting and receiving signals with respect to the reader/writer 110 in a noncontact manner, and an IC chip connected to the antenna are buried. As shown in FIG. 3, in this IC chip, an IC card control unit 11 for controlling a circuit within the IC chip, and an IC card storage unit 12 for storing various information are provided.

The IC card control unit 11 is provided with a CPU and a memory such as a RAM or a ROM, and performs a process of updating or reading the various information stored in the IC card storage unit 12 in response to an IC card command received via the antenna from outside of the contactless IC card 10.

The IC card storage unit 12 is a rewritable storage element such as an EEPROM, and an electronic money balance 12a and a user ID 12b have been stored therein. The user ID 12b is information for identifying a user of the electronic money service, and different IDs have been granted to multiple contactless IC cards 10, respectively.

Next, the respective devices provided in the electronic money charger 100 will be described. The deposit button 101 is for instructing to perform the electronic money deposit process, and when the deposit button 101 is depressed, a predetermined deposit instruction signal is transmitted to the control unit 160.

The human sensor 102 is a well-known sensor which senses thermal radiation from a human body with infrared rays, and when the human sensor 102 detects a person existing within a detectable range, the human sensor 102 transmits a predetermined detection signal to the control unit 160. It should be noted that activation of the human sensor 102 is controlled by the control unit 160.

The display unit 103 is display equipment such as a well-known liquid crystal display, and displays information received from the control unit 160.

The reader/writer 110 is provided underneath the card placement unit 106, and transmits and receives the IC card command and data with respect to the contactless IC card 10 placed on the card placement unit 106. In the reader/writer 110, an antenna (not shown) for transmitting and receiving the signals with respect to the contactless IC card 10 in the noncontact manner is provided, and the IC card command received from the control unit 160 is transmitted via the antenna to the contactless IC card 10 and also the data received via the antenna from the contactless IC card 10 is transmitted to the control unit 160.

The banknote identification device 120 is for identifying validity and a money kind of a banknote inserted into the banknote insertion slot 104, and when the banknote identification device 120 has identified that the inserted banknote is valid, the banknote identification device 120 transmits information representing the amount of the inserted banknote to the control unit 160. Moreover, in the banknote identification device 120, a banknote receiving unit 121 for receiving the inserted banknote is provided, and if the banknote identification device 120 has received a predetermined banknote receiving signal from the control unit 160, the banknote identification device 120 receives the inserted banknote in the banknote receiving unit 121. Furthermore, when the banknote identification device 120 receives a predetermined banknote returning preparation signal from the control unit 160, the banknote identification device 120 enables the inserted banknote to be returned by carrying out the inserted banknote near the banknote insertion slot 104. Furthermore, when the banknote identification device 120 receives a predetermined banknote returning signal from the control unit 160, the banknote identification device 120 returns the inserted banknote to the user by exposing a portion of the inserted banknote from the banknote insertion slot 104. In this case, other portions of the inserted banknote are supported by the banknote identification device 120, and when the banknote identification device 120 receives the banknote receiving signal from the control unit 160 in this state, the banknote identification device 120 collects the inserted banknote and receives the inserted banknote in the banknote receiving unit 121. It should be noted that a sensor (not shown) for detecting the banknote existing at the banknote insertion slot 104 is provided at the banknote insertion slot 104, and when the sensor detects the banknote, the sensor transmits a predetermined banknote detection signal to the control unit 160.

The storage unit 130 is a rewritable storage element such as the EEPROM, and history information 131 as shown in FIG. 4 and amount information 132 as shown in FIG. 5 have been stored therein. The history information 131 consists of multiple history records, and each history record is configured with a history information ID for representing a number of the history record, the user ID 12b of the contactless IC card 10, a transaction date and a deposit amount. Moreover, in the history information 131, one history record is additionally written each time the electronic money deposit process is normally completed. The amount information 132 consists of multiple amount records, and each amount record is configured with an amount information ID for representing a number of the amount record, the user ID 12b of the contactless IC card 10, the transaction date and an inserted amount. Moreover, in the amount information 132, one amount record is additionally written each time an anomaly occurs in the electronic money deposit process and the inserted amount which has been returned is received in the banknote receiving unit 121 in the banknote identification device 120. It should be noted that, multiple pieces of textual information in which contents of operations and contents of the process with respect to the deposit process have been represented by using Japanese syllabary characters and Chinese characters or Katakana characters, have been stored in the storage unit 130, and the history information 131, the amount information 132 and each textual information are read by the control unit 160.

The receipt printing unit 140 is a well-known printer for printing the result of the deposit process on a predetermined paper sheet, and prints the information received from the control unit 160 on the above described paper sheet and subsequently ejects this paper sheet as the receipt from the receipt ejection slot 105.

The communication device 150 is communication equipment such as a modem for connecting to the network 200, and performs communication with the management server 300 via the network 200. It should be noted that, in this embodiment, a public line network is used as the network 200 and the modem is correspondingly used as the communication device 150.

The control unit 160 is for controlling the entire electronic money charger 100, and is provided with a timer circuit (not shown) for obtaining a date when the deposit process has been performed (the transaction date), in addition to the CPU and the memory such as the RAM or the ROM. Moreover, the control unit 160 controls the above described respective devices based on the data and a program stored in its own memory. Multiple IC card commands and the like which will be described later have been stored in a non-rewritable area in the memory, which however is not limited thereto. These commands and the like may have been stored in the storage unit 130 and the control unit 160 may read each command from the storage unit 130 if necessary. It should be noted that operations of the control unit 160 will be described in detail below.

The management server 300 is a server for managing the electronic money service, and is configured with a communication device 310 for connecting to the network 200, a server control unit 320 for controlling the entire management server 300, and a server storage unit 330 for storing various information.

The communication device 310 is communication equipment such as the modem for connecting to the network 200 similarly to the communication device 150 in the electronic money charger 100, and performs the communication with the electronic money charger 100 via the network 200.

The server control unit 320 is provided with a CPU and a memory such as the RAM or the ROM, and stores the history information 131 and the amount information 132 received from the electronic money charger 100 via the network 200 and the communication device 310, in the server storage unit 330.

The server storage unit 330 is a rewritable storage element such as the EEPROM, and the history information 131 and the amount information 132, which have been transmitted from the electronic money chargeres 100, have been stored therein.

In the electronic money charger 100 which is configured as described above, the electronic money deposit process is performed by adding the amount of the banknote inserted into the banknote insertion slot 104 to the electronic money balance 12a of the contactless IC card 10. Moreover, the electronic money charger 100 returns the inserted banknote from the banknote insertion slot 104 when the anomaly has occurred in the electronic money deposit process, and also if the user has not been detected by the human sensor 102 in a state where the inserted banknote has been returned, the electronic money charger 100 stores the inserted banknote in the banknote receiving unit 121. Furthermore, this electronic money charger 100 can add the inserted amount stored in the amount information 132 to the electronic money balance 12a of the contactless IC card 10. Hereinafter, operations of the electronic money charger 100 will be described with reference to FIGS. 6 and 7.

First, when the electronic money charger 100 is powered on, the control unit 160 causes the display unit 103 to display a message for guiding the user to place the contactless IC card 10 on the card placement unit 106, as shown in FIG. 7(a) (step S1). In this case, the control unit 160 extracts textual information for guiding the user to place the contactless IC card 10 on the card placement unit 106, from the storage unit 130, and causes the display unit 103 to display the textual information. Moreover, the control unit 160 transmits the IC card command for obtaining a predetermined response signal from the contactless IC card 10, via the reader/writer 110 to the contactless IC card 10. It should be noted that, in this embodiment, a card ID (not shown) specific to the contactless IC card 10 is used as the response signal.

Next, when the user places the contactless IC card 10 on the card placement unit 106, the IC card control unit 11 in the contactless IC card 10 transmits the response signal with respect to the IC card command received from the reader/writer 110. The control unit 160 detects the contactless IC card 10 by receiving the response signal via the reader/writer 110 from the contactless IC card 10 (step S2).

Next, the control unit 160 performs a query with respect to the management server 300 (step S3). Specifically, the control unit 160 first transmits the IC card command for reading the electronic money balance 12a and the user ID 12b, via the reader/writer 110 to the contactless IC card 10. On the other hand, when the IC card control unit 11 in the contactless IC card 10 receives the above described IC card command, the IC card control unit 11 transmits the electronic money balance 12a and the user ID 12b in the IC card storage unit 12 to the reader/writer 110. Then, the control unit 160 stores the respective information 12a and 12b received via the reader/writer 110 from the contactless IC card 10, in the RAM. Next, the control unit 160 transmits the user ID 12b via the communication device 150 to the management server 300. When the server control unit 320 in the management server 300 receives the user ID 12b from the electronic money charger 100, the server control unit 320 extracts the amount record having the same user ID as the received user ID 12b from the amount information 132 in the server storage unit 330, and transmits the extracted amount record to the electronic money charger 100. It should be noted that if there is no amount record having the same user ID as the received user ID 12b in the amount information 132, the server control unit 320 transmits data representing that there is no amount record, to the electronic money charger 100.

Next, the control unit 160 determines whether or not the amount record has been received (step S4), and if the data representing that there is no amount record has been received, the control unit 160 causes the display unit 103 to display the electronic money balance 12a received from the contactless IC card 10 and a message for guiding the user to charge in cash, on the display unit 103, as shown in FIG. 7(b) (step S5). Then, when the user inserts the banknote into the banknote insertion slot 104 (step S6), the banknote identification device 120 identifies the validity and the money kind of the inserted banknote, and if the banknote identification device 120 determines the validity of the inserted banknote, the banknote identification device 120 transmits the information representing the amount of the inserted banknote to the control unit 160. Then, the control unit 160 causes the display unit 103 to display the information received from the banknote identification device 120 as shown in FIG. 7(c) (step S7). Moreover, the control unit 160 repeats the above described processes at steps S6 and S7 until the deposit button 101 is depressed. In this case, a total amount of the inserted banknotes is displayed on the display unit 103.

Then, when the deposit button 101 is depressed and thereby the control unit 160 receives the deposit instruction signal (step S8), the control unit 160 performs the electronic money deposit process with respect to the contactless IC card 10 (step S9).

Here, the electronic money deposit process will be specifically described. The control unit 160 transmits the IC card command for adding the total amount of the inserted banknotes to the electronic money balance 12a, via the reader/writer 110 to the contactless IC card 10. On the other hand, when the IC card control unit 11 receives the above described IC card command from the reader/writer 110, the IC card control unit 11 adds the total amount of the inserted banknotes included in the IC card command to the electronic money balance 12a, and subsequently transmits a predetermined addition completion signal to the reader/writer 110. Then, when the control unit 160 receives the addition completion signal via the reader/writer 110, the electronic money deposit process is normally completed. It should be noted that, while the electronic money deposit process is performed, the control unit 160 causes the display unit 103 to display a message for guiding the user not to remove the contactless IC card 10 from the card placement unit 106, as shown in FIG. 7(d).

Moreover, if the electronic money deposit process has been normally completed (step S10), the control unit 160 receives the inserted banknotes into the banknote receiving unit 121 by transmitting the banknote receiving signal to the banknote identification device 120 (step S11). At this time, the control unit 160 transmits the user ID 12b, the date obtained from the timer circuit (the transaction date), and the total amount of the inserted banknotes (the deposit amount) to the receipt printing unit 140, and also causes the receipt printing unit 140 to print the receipt on which this information has been described. Next, the control unit 160 generates the history record which consists of the history information ID, the user ID 12b, the transaction date and the deposit amount, and additionally writes the history record to the history information 131 in the storage unit 130 (step S12).

Next, an operation in the case where the anomaly has occurred in the electronic money deposit process will be described. At the above described step S9, if there is no reply from the contactless IC card 10 with respect to the IC card command transmitted to the contactless IC card 10, or if the addition completion signal is not transmitted from the contactless IC card 10, the control unit 160 determines that the anomaly has occurred in the electronic money deposit process, and transmits the banknote returning preparation signal to the banknote identification device 120. When the banknote identification device 120 receives the banknote returning preparation signal from the control unit 160, the banknote identification device 120 carries out the inserted banknotes to inside of the banknote insertion slot 104 to enable the inserted banknotes to be returned, and thereby prepares for returning the inserted banknotes (step S13).

Then, the control unit 160 sets the inserted banknotes to a returnable state, subsequently activates the human sensor 102, and determines whether or not the user exists within a predetermined range (step S14). In this case, the control unit 160 determines that the user exists within the predetermined range by receiving the detection signal from the human sensor 102. Moreover, the control unit 160 performs a detection process of the contactless IC card 10 by receiving the user ID 12b via the reader/writer 110 from the contactless IC card (step S15). At this time, the control unit 160 compares the received user ID 12b with the user ID 12b obtained at step S3, and if both user IDs 12b are identical with each other, the control unit 160 determines that the contactless IC card 10 has been detected. If both user IDs 12b are different from each other, or if the control unit 160 cannot receive the user ID 12b from the contactless IC card 10, the control unit 160 determines that the contactless IC card 10 has not been detected.

It should be noted that if the user has been detected at step S14 or if the contactless IC card 10 has been detected at step S15, the control unit 160 returns the inserted banknotes by transmitting the banknote returning signal to the banknote identification device 120 (step S16). In this case, a portion of the inserted banknote is exposed from the banknote insertion slot 104, which enables the user to remove the inserted banknotes from the banknote insertion slot 104. It should be noted that the control unit 160 causes the display unit 103 to display a message for guiding the user to remove the inserted banknotes and the contactless IC card 10, as shown in FIG. 7(e).

Next, if the control unit 160 has received the banknote detection signal from the sensor provided at the banknote insertion slot 104 in a state where the user and the contactless IC card 10 have not been detected (step S17), the control unit 160 receives the inserted banknotes in the returnable state or in a state of being exposed from the banknote insertion slot 104, into the banknote receiving unit 121 by transmitting the banknote receiving signal to the banknote identification device 120 (step S18). Then, the control unit 160 generates the amount record which consists of the amount information ID, the user ID 12b, the date obtained from the timer circuit (the transaction date) and the total amount of the inserted banknotes (the inserted amount), and additionally writes the amount record to the amount information 132 in the storage unit 130 (step S19).

Next, an operation in the case of adding the inserted amount stored in the amount information 132 to the contactless IC card 10 will be described. When the control unit 160 receives the amount record from the management server 300 at the above described step S3, the control unit 160 causes the display unit 103 to display a message for guiding the user to charge the inserted amount in the amount record as shown in FIG. 7(f) (step S20). Then, when the user depresses the deposit button 101 (step S21), the control unit 160 performs the electronic money deposit process (step S22). In this case, the control unit 160 transmits the IC card command for adding the inserted amount in the amount record to the electronic money balance 12a, via the reader/writer 110 to the contactless IC card 10. On the other hand, when the IC card control unit 11 receives the above described IC card command from the reader/writer 110, the IC card control unit 11 adds the inserted amount included in the IC card command to the electronic money balance 12a, and subsequently transmits the addition completion signal to the reader/writer 110. Then, when the control unit 160 receives the addition completion signal via the reader/writer 110, the control unit 160 transmits a predetermined amount record deletion signal including the amount information ID corresponding to the inserted amount, to the management server 300. When the server control unit 320 in the management server 300 receives the amount record deletion signal, the server control unit 320 deletes the amount record corresponding to the amount information ID included in the record deletion signal, from the server storage unit 330, and transmits a predetermined deletion completion signal to the electronic money charger 100. Then, when the control unit 160 receives the deletion completion signal, the electronic money deposit process is normally completed.

It should be noted that the control unit 160 transmits the history information 131 and the amount information 132 which have been stored at steps S12 and S19, respectively, to the management server 300 at an arbitrary time, although a description thereof has been omitted in the above described flow. The server control unit 320 in the management server 300 stores the received history information 131 and the received amount information 132 in the server storage unit 330.

Moreover, if multiple amount records have been transmitted from the management server 300 at the above described step S3, the control unit 160 may add a summation of the inserted amounts of the respective amount records to the electronic money balance 12a of the contactless IC card 10 when the deposit button 101 has been depressed. Furthermore, a selection button for selecting the amount record may be provided at the front side of the electronic money charger 100, and the inserted amount of the amount record selected by the selection button may be added to the electronic money balance 12a.

In this way, according to the electronic money charger 100 of this embodiment, the banknote receiving unit 121 which receives the inserted banknote, the human sensor 102 which detects the user who has inserted the banknote, and the control unit 160 which controls to prepare for returning an inserted currency when the anomaly has occurred in the electronic money deposit process and also to store the inserted banknote in the banknote receiving unit 121 if the user has not been detected by the human sensor 102 in a state prepared for returning the inserted banknote are provided. Consequently, for example, even though the anomaly has occurred in the electronic money deposit process, if the user has mistakenly recognized that the deposit process has been normally completed, and left there, the inserted banknote can be stored in the banknote receiving unit 121. Therefore, it is possible to prevent the inserted banknote which has been returned, from being freely removed, and also possible to certainly prevent the inserted banknote from being carried away by a third party.

Moreover, if the user is not detected by the human sensor 102 in the state prepared for returning the inserted banknote and there is no contactless IC card 10 communicable via the reader/writer 110, the control unit 160 stores the inserted banknote in the banknote receiving unit 121. Thereby, for example, even if the user is incidentally at a position which is not detected by the human sensor 102, when the contactless IC card 10 of the user and the reader/writer 110 can communicate with each other, the inserted banknote is not stored in the banknote receiving unit 121. Therefore, the electronic money charger 100 of this embodiment can surely return the inserted banknote, which can improve convenience to the user.

Furthermore, if the user has not been detected by the human sensor 102 in the state prepared for returning the inserted banknote, the control unit 160 stores the inserted banknote in the banknote receiving unit 121 and also stores the amount of the inserted banknote in the storage unit 130. Thereby, for example, based on the amount of the inserted banknote stored in the storage unit 130, it is operationally possible to separately return the inserted banknote with respect to the user. Therefore, the electronic money charger 100 of this embodiment can improve the convenience to the user.

Furthermore, since the server storage unit 330 which stores the amount of the inserted banknote has been provided in the management server 300 connected via the network 200, the management server 300 can collectively manage the amount of the inserted banknote which has not been removed by the user and has stored in the banknote receiving unit 121. Therefore, it is easily possible for the electronic money charger 100 of this embodiment to separately return the inserted banknote with respect to the user.

Moreover, if the user has not been detected by the human sensor 102 in the state prepared for returning the inserted banknote, the control unit 160 stores the user ID 12b of the contactless IC card 10 read via the reader/writer 110 and the amount of the inserted banknote, in the server storage unit 330, and subsequently, when the user ID 12b of the contactless IC card 10 is read via the reader/writer 110, the control unit 160 adds the amount of the inserted banknote which has been stored along with the user ID 12b, to the electronic money balance 12a of the contactless IC card 10. Thereby, the control unit 160 can separately perform the electronic money deposit process by using the amount of the inserted banknote stored in the server storage unit 330. Therefore, the electronic money charger 100 of this embodiment can further improve the convenience to the user.

It should be noted that the above described embodiment is nothing more than a specific example of the present invention and the present invention is not limited only to the above described embodiment. For example, although the above described embodiment has shown that the contactless IC card 10 is used as a storage medium, in addition, a mobile phone mounted with an RFID (Radio Frequency Identification) tag or an IC chip, or the like may be used as the storage medium.

Moreover, although the above described embodiment has shown that the electronic money deposit process is performed by using the amount record stored in the management server 300, the electronic money deposit process may be performed by using the amount record in the amount information 132 stored in the storage unit 130. In this case, whether the amount record is stored in the server storage unit 330 or the storage unit 130 may be configured to be appropriately changeable by providing setting means such as a switch connected to the control unit 160.

Furthermore, the above described embodiment has shown that, if the anomaly has occurred in the electronic money deposit process, the preparation for returning the banknote is performed and the inserted banknote is set to the returnable state. However, it may be configured to set the inserted banknote to the returnable state by exposing a portion of the inserted banknote from the banknote insertion slot 104.

Furthermore, although the above described embodiment has shown that only the banknotes are used as inserted currencies, of course the above described embodiment is also applicable to the case of using coins.

1. An electronic money charger, comprising:
a reader/writer which reads and writes data with respect to a storage medium in which an electronic money balance used in an electronic money service has been stored;
a currency receiving unit which receives an inserted currency;
a user detection unit which detects a user who has inserted the currency; and
control means which has control to perform an electronic money deposit process by adding an amount of the inserted currency to the electronic money balance in the storage medium via the reader/writer, control to enable the inserted currency to be returned when an anomaly has occurred in said deposit process, and control to store the inserted currency in the currency receiving unit if the user has not been detected by the user detection unit in a state where the inserted currency is returnable.

2. The electronic money charger according to claim 1, wherein:
if the user is not detected by the user detection unit in the state where the inserted currency is returnable and if there is no storage medium communicable via the reader/writer, said control means stores the inserted currency in the currency receiving unit.

3. The electronic money charger according to claim 1, wherein:
if the user has not been detected by the user detection unit in the state where the inserted currency is returnable, said control means stores the inserted currency in the currency receiving unit and also stores the amount of the inserted currency in a predetermined storage unit.

4. The electronic money charger according to claim 3, wherein:
said storage unit is provided in a predetermined management server connected via a network.

5. The electronic money charger according to claim 3, wherein:
if the user has not been detected by the user detection unit in the state where the inserted currency is returnable, said control means stores identification information in the storage medium read via the reader/writer and the amount of the inserted currency, in said storage unit, and subsequently, when the identification information in the storage medium is read via the reader/writer, said control means adds the amount of the inserted currency which has been stored in the storage unit along with the identification information, to the electronic money balance in the storage medium.
